(19) United States
(12) Patent Application Publication
(10) Pub. No.: US 2008/0013352 A1
(43) Pub. Date: Jan. 17, 2008

(54) Active rectifier system with power factor correction

(76) Inventor: Donal E. Baker, Rockford, IL (US)

Correspondence Address: STEPHEN GEORGE MICAN, POST OFFICE BOX 1347, WEST POINT, CA, 95255-1347, US

(21) Appl. No.: 11/485,953

(22) Filed: Jul. 13, 2006

(51) Int. Cl. H02M 7/00

(52) U.S. Cl. 363/125

(57) ABSTRACT

A polyphase alternating current (AC) active rectifier system converts polyphase AC from an AC source to direct current (DC) on a DC bus comprising a positive DC bus line and a negative DC bus line with a switching element for each phase configured to direct current from the AC source to the DC bus through four different conducting paths with three electrical potential levels, including a positive DC level on the positive DC bus line, a negative DC level on the negative DC bus line and a neutral DC level between the positive and negative DC level on a neutral DC bus line and suppresses AC common mode electrical potential from the DC bus, comprising: a ground path between the neutral DC bus line and a system ground coupled to a neutral point for the AC source that clamps the level of the neutral DC level to the AC source neutral.

### FIELD OF THE INVENTION

The invention relates to polyphase alternating current (AC) to direct current (DC) rectifier systems, and more particularly to AC to DC active rectifier system that incorporate power factor correction.

### BACKGROUND OF THE INVENTION

The aircraft industry is rapidly switching to new electric power systems that need DC power to feed various motor drives to control electric motors for aeronautical applications such as engine starting, environmental conditioning systems, hydraulic pumps and fuel pumps, to name a few. Gas turbine engine driven polyphase AC generators, generally of the three-phase type, supply needed AC power. Rectifier systems generally convert the available three-phase AC power from the generators to DC power required for such motor drives. However, because these loads are nonlinear and relatively large compared to the generator rating, distortion becomes a serious issue when using large rated rectifiers.

Conventional passive rectifier systems for converting three-phase AC to DC are generally simple and inexpensive. However, passive rectifier systems generally have a relatively low power factor and relatively high distortion when coupled to reactive and nonlinear loads, such as motor drives. This is primarily due to the discontinuous current draw from the AC power bus by the rectifier system due to the non-linear load that it supplies. In fact, a conventional passive six-pulse rectifier system creates so much odd harmonic distortion with such loads that other types are generally required. Even a 12-pulse passive rectifier system, which is capable of suppressing odd harmonics of the AC supply frequency below the 11^{th}, still insufficiently eliminates undesirable harmonic input current effects on the AC system that supplies it. An 18-pulse rectifier system is capable of suppressing odd harmonics of the AC supply frequency below the 17^{th}, so it has the capability to meet the harmonic demands of modern aeronautical electric power systems, but such an 18-pulse rectifier system difficult to physically realize and it is heavy, due to the necessity of needing a transformer with three secondary windings and three six-diode rectifier assemblies.

An active rectifier system is a potential candidate for modern high power aeronautical electrical systems. An active high power rectifier system may easily operate at 400 to 800 Hz and provide low distortion effects on the AC power bus that supplies it. One such candidate is the “Vienna” rectifier that finds common application in the 60 Hz utility power industry to rectify AC power directly off-line for the telecommunications industry.

The Vienna rectifier is effectively a three-phase boost switching power electronic circuit capable of both positive and negative polarity operation from each input phase. It operates much like a conventional six-diode passive rectifier but has the ability to draw much lower distortion current component from the AC bus that supplies it. This is because it draws relatively constant current that is in phase with the electrical potential on the AC bus regardless of load. The continuous current feature of its boost topology makes this type of boost switching active rectifier attractive for high power aeronautical applications. The basic topology of the Vienna rectifier has an inherent high power factor that is near unity. Therefore, it does not allow the Vienna rectifier to pass power in the reverse direction, even on a sub cycle basis. This feature helps control system stability issues that encumber other types of active rectifiers, such as those that employ the dc-link inverter topology.

Like all circuits, the Vienna rectifier has advantages and disadvantages. One major disadvantage is that it has a high common mode electrical potential characteristic. That means that the electrical potential of its output moves relative to the electrical potential of its AC supply source. This common mode potential is about 25 percent of the peak input potential of the AC source and it has a waveform with a fundamental frequency that is the third harmonic of the AC source frequency, with a generally triangular shape for sinusoidal AC input voltages. This is nearly identical to the harmonic distortion waveform for the simple six-pulse passive rectifier. It is too large in magnitude and harmonic content to satisfy aircraft power system emission specifications for high power aeronautical electrical power systems. Existing 18-pulse passive rectifier systems are heavy, but they do a good job of minimising the common mode electrical potential so that additional filtering is not necessary. Accordingly, an active rectifier system that provides the near unity power factor of the Vienna rectifier with the low common mode electrical potential of an 18-pulse passive rectifier system would be ideal for high power aeronautical electrical systems.

### SUMMARY OF THE INVENTION

The invention modifies the Vienna rectifier system configuration to establish the electrical potential of the neutral point of its DC output to be at the same level as the neutral point of the AC source that supplies it. A direct connection between the DC and AC neutrals achieves this purpose. Since the neutral point of the DC output of a Vienna rectifier system comprises common mode electrical potential that induces harmonic distortion into the AC source, the direct connection between the DC neutral and AC source neutral suppresses this common mode electrical potential to reduce harmonic distortion significantly.

Generally, the invention comprises a polyphase alternating current (AC) active rectifier system for converting polyphase AC from an AC source to direct current (DC) on a DC bus comprising a positive DC bus line and a negative DC bus line with a switching element for each phase configured to direct current from the AC source to the DC bus through four different conducting paths with three electrical potential levels, including a positive DC level on the positive DC bus line, a negative DC level on the negative DC bus line and a neutral DC level between the positive and negative DC level on a neutral DC bus line that suppresses AC common mode electrical potential from the DC bus, comprising: a ground path between the neutral DC bus line and a system ground coupled to a neutral point for the AC source that clamps the level of the neutral DC level to the AC source neutral.

### DESCRIPTION OF THE DRAWINGS

FIG. 1 is a schematic diagram of a prior art active rectifier system of the Vienna rectifier type.

FIG. 2 is a schematic diagram of an active rectifier system with low harmonic distortion according to a possible embodiment of the invention.

### DETAILED DESCRIPTION OF THE INVENTION

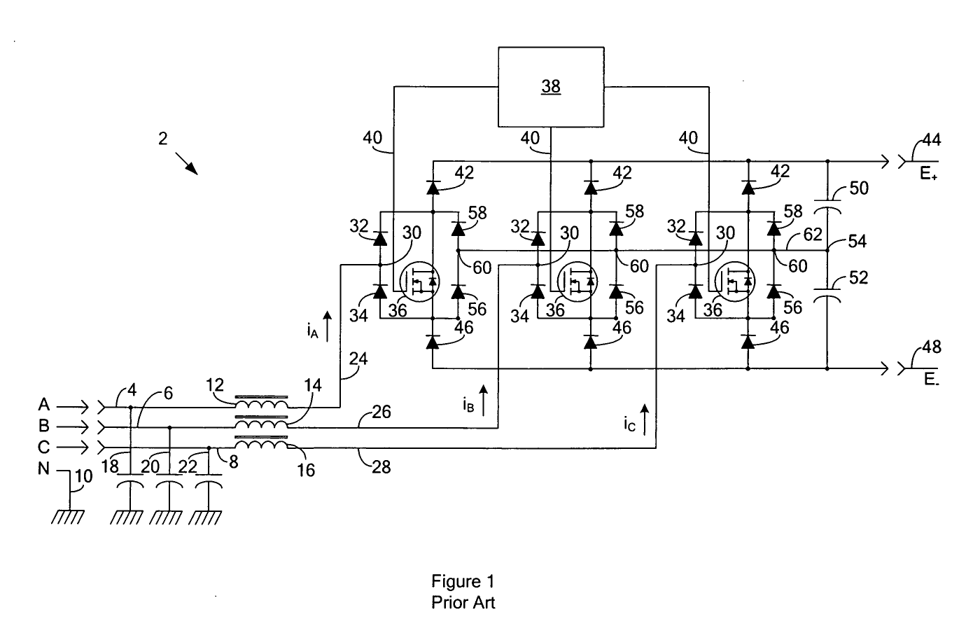

FIG. 1 is a schematic diagram of a prior art active rectifier system 2 of the Vienna rectifier type. A polyphase AC power source (not shown) typically supplies AC power in three phases A, B and C represented by terminals A, B and C that has a fundamental AC power frequency, typically 400 to 800 Hz, by way of AC input lines 4, 6 and 8. The neutral point of the AC power source represented by terminal N couples to AC system ground by way of AC system ground line 10.

As common with rectifier systems of the switching type, the AC input lines 4, 6 and 8 feed AC current through inputs of inductors 12, 14 and 16 for phases A, B and C, respectively. The rectifier system may include capacitors 18, 20 and 22 coupled between outputs of each of the inductors 12, 14 and 16 and the AC system ground to attenuate high frequency harmonics of the AC power fundamental frequency that the Vienna type rectifier system 2 generates.

Current from the output of each of the inductors 12, 14 and 16 flows through inductor output lines 24, 26 and 28 respectively to respective junctions 30 of respective series connected pairs of input diodes 32 and 34. Respective switching elements 36, such as insulated gate bipolar transistors (IGBTs) connect across each series connected pair of input diodes 32 and 34. A rectifier system switching controller 38 switches the switching elements 36 on and off by way of control lines 40 as hereinafter described.

When a switching element 36 switches off, positive current that flows into the junction 30 for its respective series connected pair of input diodes 32 and 34 passes through its positive input diode 32 and through a respective positive output diode 42 into a positive output line 44 of a DC bus. Likewise, when a switching element 36 switches off, negative current that flows into the junction 30 for its respective series connected pair of input diodes 32 and 34 passes through its negative input diode 34 and through a respective negative output diode 46 into a negative output line 48 of a DC bus. A series connected pair of output capacitors 50 and 52 with a junction 54 connect from the positive output line 44 and the negative output line 48 of the DC bus. The junction 54 represents the neutral point for the DC bus.

A series connected pair of shunt diodes 56 and 58 with a junction 60 connect across each switching element 36. When a switching element 36 switches on, positive current flows through the positive shunt diode 56 and the junction 60 for its respective series connected pair of shunt diodes 56 and 58 and then into a DC bus neutral line 62 that connects to the junction 54 for the output capacitors 50 and 52. Likewise, when a switching element 36 switches off, negative current flows through the negative shunt diode and the junction 60 for its respective series connected pair of shunt diodes 56 and 58 and then into the DC bus neutral line 62.

Consequently, there are four different conduction paths for current through the Vienna type rectifier system 2 for each phase of the power supplied by the AC power source depending on the phase of the current and the state of the switching elements 36. For each phase, current flows to either the positive DC bus 44 or the negative DC bus 48 when its respective switching element 36 switches off or to the DC neutral line 62 when its respective switching element 36 switches on. Therefore, the Vienna type rectifier system 2 also has three different electrical potential levels that correspond to these four different conduction paths.

The Vienna type rectifier operates in current mode control. That is, the switching controller 38 controls the states of the switching elements 36, typically at a high frequency rate that may be as high as approximately 10 to 50 kHz, to control the input phase currents on a real time basis so that they resemble pure sine-waves and thus create minimal harmonic distortion reflected back to the AC power source. Various control strategies are available for this feature, including hysteresis current control and space-vector current derived switching patterns. In any case, the object is to provide an input phase current that replicates the input phase electrical potential shape and phase angle regardless of load, input voltages and so forth.

A serious problem with the Vienna type rectifier system 2 is that the electrical potential on the DC bus neutral line 62 fluctuates because it comprises a common mode potential that is about 25 percent of the peak input potential of the AC source and it has a waveform with a fundamental frequency that is the third harmonic of the AC source frequency, with a generally triangular shape for sinusoidal AC input voltages. As hereinbefore described, this distortion may reflect back to the AC power source and it is too large in magnitude and harmonic content to satisfy aircraft power system emission specifications for high power aeronautical electrical power systems.

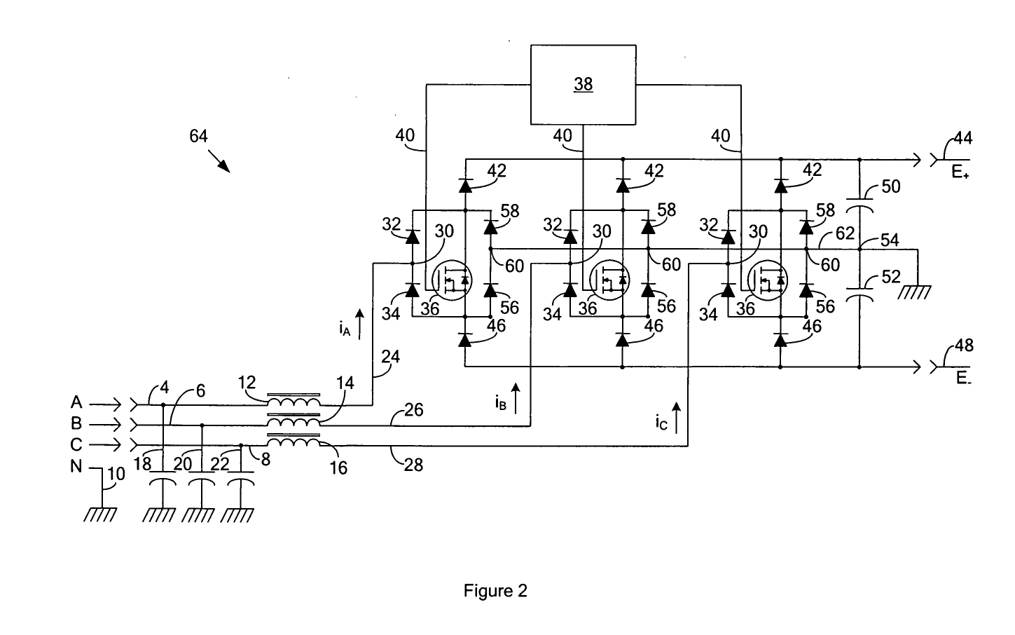

FIG. 2 is a schematic diagram of an active rectifier system 64 with low harmonic distortion according to a possible embodiment of the invention. Because of the current mode control on the input to the Vienna type rectifier system 2 described in connection with FIG. 1, it may operate with the DC neutral line 62 clamped to the AC source neutral when the output centre point connects to AC system ground with a grounding line 66 coupled to the junction 54 as shown in FIG. 2. If the switching controller 32 is of the current hysteresis type, it may accommodate this modification without change. If the switching controller 32 is of the space vector type, it may accommodate this modification with as little as some minor pulse width table changes to the space-vector switching algorithms, as shall be appreciated by those skilled in the art of software development.

Clamping the DC bus neutral line to the AC system ground effectively drops the undesired common mode electrical potential cross the boost converter and therefore it requires no additional filter inductors. This removes the common mode electrical potential from the output of the DC bus and any connected DC loads. Accordingly, any connected DC loads do not have to add filtering to absorb this common mode electrical potential.

The described embodiment of the invention is only an illustrative implementation of the invention wherein changes and substitutions of the various parts and arrangement thereof are within the scope of the invention as set forth in the attached claims.

The claimed invention is:

1. A polyphase alternating current (AC) active rectifier system for converting polyphase AC from an AC source to direct current (DC) on a DC bus comprising a positive DC bus line and a negative DC bus line with a switching element for each phase configured to direct current from the AC source to the DC bus through four different conducting paths with three electrical potential levels, including a positive DC level on the positive DC bus line, a negative DC level on the negative DC bus line and a neutral DC level between the positive and negative DC level on a neutral DC bus line that suppresses AC common mode electrical potential from the DC bus, comprising:
a ground path between the neutral DC bus line and a system ground coupled to a neutral point for the AC source that clamps the level of the neutral DC bus to the AC source neutral.

2. The rectifier system of claim 1, wherein the polyphase AC comprises three phase AC.

3. The rectifier system of claim 1, wherein a pair of series connected output capacitors connect across the positive and negative DC bus lines and their junction connects to the DC neutral line.

4. The rectifier system of claim 1, further comprising an input inductor for each phase, wherein each switching element selectively couples its respective input inductor to the DC neutral line.

5. The rectifier system of claim 1, further comprising a switching controller for controlling each switching element.

6. The rectifier system of claim 5, wherein the switching controller switches each switching element at a high frequency rate.

7. The rectifier system of claim 5, wherein the switching controller is of the current hysteresis type.

8. The rectifier system of claim 5, wherein the switching controller is of the space-vector current type.

9. A three phase alternating current (AC) active rectifier system for converting three phase AC from an AC source to direct current (DC) on a DC bus comprising a positive DC bus line and a negative DC bus line with a switching element for each phase configured to direct current from the AC source to the DC bus through four different conducting paths with three electrical potential levels, including a positive DC level on the positive DC bus line, a negative DC level on the negative DC bus line and a neutral DC level between the positive and negative DC level on a neutral DC bus line that suppresses AC common mode electrical potential from the DC bus, comprising:
a pair of series connected output capacitors connect across the positive and negative DC bus lines and their junction connects to the DC neutral line;
an input inductor for each phase, wherein each switching element selectively couples its respective input inductor to the DC neutral bus line; and
a ground path between the neutral DC bus line and a system ground coupled to a neutral point for the AC source that clamps the level of the neutral DC bus to the AC source neutral.

10. The rectifier system of claim 9, further comprising a switching controller for controlling each switching element.

11. The rectifier system of claim 10, wherein the switching controller switches each switching element at a high frequency rate.

12. The rectifier system of claim 10, wherein the switching controller is of the current hysteresis type.

13. The rectifier system of claim 10, wherein the switching controller is of the space-vector current type.

14. A three phase alternating current (AC) active rectifier system for converting three phase AC from an AC source to direct current (DC) on a DC bus comprising a positive DC bus line and a negative DC bus line with a switching element for each phase configured to direct current from the AC source to the DC bus through four different conducting paths with three electrical potential levels, including a positive DC level on the positive DC bus line, a negative DC level on the negative DC bus line and a neutral DC level between the positive and negative DC level on a neutral DC bus line that suppresses AC common mode electrical potential from the DC bus, comprising:
a pair of series connected output capacitors connect across the positive and negative DC bus lines and their junction connects to the DC neutral line;
an input inductor for each phase, wherein each switching element selectively couples its respective input inductor to the DC neutral bus line;
a switching controller for controlling each switching element; and
a ground path between the neutral DC bus line and a system ground coupled to a neutral point for the AC source that clamps the level of the neutral DC bus to the AC source neutral.

15. The rectifier system of claim 14, wherein the switching controller switches each switching element at a high frequency rate.

16. The rectifier system of claim 14, wherein the switching controller is of the current hysteresis type.

17. The rectifier system of claim 14, wherein the switching controller is of the space-vector current type.
